(19) United States
(12) Patent Application Publication
(10) Pub. No.: US 2016/0284072 A1
(43) Pub. Date: Sep. 29, 2016

(54) SYSTEM FOR PHOTO CUSTOMIZABLE CARICATURE GENERATION FOR CUSTOM PRODUCTS

(71) Applicant: Sarah Hsu, New York, NY (US)

(72) Inventor: Sarah Hsu, New York, NY (US)

(73) Assignee: Sarah Sibley Hsu, New York, NY (US)

(21) Appl. No.: 15/048,478

(22) Filed: Feb. 19, 2016

Related U.S. Application Data
(60) Provisional application No. 62/118,135, filed on Feb. 19, 2015.

(51) Int. Cl. G06T 5/50; G06T 5/20; G06T 11/00; G06T 5/00

(52) U.S. Cl. CPC G06T 5/50; G06T 5/002; G06T 5/20; G06T 11/001

(57) ABSTRACT

A technology which enables, via a computer, selecting a sample configuration that fits into an image of existing artwork that can be manipulated. The technology enables, via the computer, selecting a second image, from an area that encompasses the square boundary of a first image. The technology enables applying, via the computer, a filter to the second image. The technology enables generating, via the computer, a third image generated from the placement of the second image onto a fourth image. The technology enables generating, via the computer, a fifth image from the placement of a third image onto a sixth image.

### CROSS-REFERENCE TO RELATED APPLICATIONS

The present application claims the benefit of U.S. Provisional Ser. No. 62/118,135 filed 19 Feb. 2015, which is incorporated herein by reference in its entirety for all purposes.

### BACKGROUND

In the present disclosure, where a document, an act and/or an item of knowledge is referred to and/or discussed, then such reference and/or discussion is not an admission that the document, the act and/or the item of knowledge and/or any combination thereof was at the priority date, publicly available, known to the public, part of common general knowledge and/or otherwise constitutes prior art under the applicable statutory provisions; and/or is known to be relevant to an attempt to solve any problem with which the present disclosure is concerned with. Further, nothing is disclaimed.

A website, delivered through a computer server to an end-user on either a computer or mobile device, allows a user to upload a digital picture of a face, apply digital image processing techniques to that image to match a specific style of existing artistic scenery, put that image on a existing art to create a digital avatar and place that avatar on a larger image, or scene. The product described is the method of using a computer interface or portable device to do this particular caricature generation for the purpose of putting those generated images onto an item that may be purchased.

### BRIEF SUMMARY

The present disclosure at least partially addresses the limitation of existing systems and methods. However, the present disclosure can prove useful to other technical areas. Therefore, the claims should not be construed as necessarily limited to addressing any of the above.

An embodiment comprises a method comprising overlaying, via a computer or mobile device to a server containing an extant set of instructions and algorithms, a composite digital image. The composite image is obtained from the overlaying, in sequential order, via a computer, a first image, a second image, a third image, a fourth image and a fifth image. The first image is a reference image, containing existing imagery. The second image contains a digital image representing an image on which the pixels, the smallest unit of color in a digital image, have been altered according to an adjustable fixed processing algorithm, via the computer, from a sixth image. A sixth image is a digital image representing a face located on the server. The third image is a digital image representing a semi-transparent visage representing hair, containing color, black and transparent pixels located on the server. The fourth image is a digital image semi-transparent visage representing a body figure, containing color, black and transparent pixels located on the server. The fifth image is a digital image representing text and words, containing color, black and transparent pixels located on the server.

An embodiment comprises a system comprising of a hardware processor and a memory coupled to the hardware processor. The memory stores a set of instructions to execute via the hardware processor. The instructions instruct the hardware processor to perform a method overlaying a composite digital image. The composite image is obtained from the composting of the first, second, third, fourth and fifth images. The first image is a reference image, containing existing imagery, stored in memory. The second image contains a digital image representing a face on which the pixels have been altered according to an adjustable fixed processing algorithm from a sixth image. A sixth image is a digital image representing a face located on the server. The third image is a digital image representing a semi-transparent visage representing hair, containing color, black and transparent pixels generated by a set of instructions. The fourth image is a digital image semi-transparent visage representing a body figure, containing color, black and transparent pixels generated by a set of instructions. The fifth image is a digital image representing text and words, containing color, black and transparent pixels located on the server generated by a set of instructions.

An embodiment comprises a storage device storing a set of instructions to execute via a processing circuit to implement a method comprising composing, via a computer, a composite digital image obtained by composing a first, second, third, fourth and fifth images. The second image contains a digital image representing a face on which the pixels have been altered according to an adjustable fixed processing algorithm from a sixth image. A sixth image is a digital image representing a face located on the server. The third image is a digital image representing a semi-transparent visage representing hair, containing color, black and transparent pixels generated by a set of instructions. The fourth image is a digital image semi-transparent visage representing a body figure, containing color, black and transparent pixels generated by a set of instructions. The fifth image is a digital image representing text and words, containing color, black and transparent pixels located on the server generated by a set of instructions.

### BRIEF DESCRIPTION OF THE DRAWINGS

The accompanying drawings illustrate example embodiments of the present disclosure. Such drawings are not to be construed as necessarily limiting the disclosure. Like numbers and/or similar numbering scheme can refer to like and/or similar elements throughout.

FIG. 1A shows a sample selectable caricature of a male body with symbols generally known to reflect symbols referring to either female or male representations.

FIG. 1B shows a sample selectable caricature of a female body with symbols generally known to reflect symbols referring to either female or male representations.

FIG. 2 shows an existing digital image that has been heretofore placed onto the server.

FIG. 3A shows a smaller representation of a portion of an digital image

FIG. 3B shows an existing digital image unto which a user designates a set of coordinates using a cursor the location of the area of the image to be represented in the smaller representation

FIG. 4A shows a collection of colors that represent a feature of a subset of the analysis

FIG. 4B shows an optional digital image that can be overlaid over an image

FIG. 4C shows an optional digital image representing hair that can be overlaid on an image

FIG. 4D shows the optional digital images overlaid on a processed face image

FIG. 5A shows an composed head image that is placed on top of a figure

FIG. 5B shows a collection of colors that represent a feature of a subset of the analysis as well the option to select an image onto which a previous image may be composed

FIG. 6 shows a composite scene onto which one or more previously composed bodies may be placed onto a specific horizontal space

FIG. 7A shows a field where features that customizes generation of text entries can be modified

FIG. 7B shows a final output of all features that have been customized

FIG. 8 shows a computer interface where the user may interact with the preferred embodiment

FIG. 9 shows a flowchart for the preferred embodiment

### DETAILED DESCRIPTION OF THE PREFERRED EMBODIMENTS

The present disclosure is now described more fully with reference to the accompanying drawings, in which an example embodiment of the present disclosure is shown. The present disclosure can, however, be embodied in several forms and should not be construed as necessarily being limited to the example embodiment disclosed herein. Rather, this example embodiment is provided so that the present disclosure is thorough and complete, and fully conveys the concepts of the present disclosure to those skilled in the relevant art. In addition, features described with respect to certain example embodiments can be combined in and/or with various other example embodiments. Different aspects and/or elements of example embodiments, as herein disclosed, can be combined in a similar manner.

The terminology used herein can imply indirect or direct, fully or partially, temporarily or permanently, action or inaction. For example, if an element is referred to as being “on”,“connected” or “coupled” to another element, then the element can be directly on, connected to the other element and/or intervening elements may be present, including indirect and/or direct variants. In contrast, when an element is referred to as being “directly connected” or “directly coupled” to another element, there are no intervening elements present.

Although the terms first, second, etc. can be used herein to describe different elements, components, layouts, layers and/or sections, these elements, components, layouts, layers and/or sections should not necessarily be limited by such terms. These terms are used to distinguish one element, component, layout, layer or section from another element, component, layouts, layer or section. Thus, a first element, component, layout, layer, or section discussed below could be termed a second element, component, layout, layer, or section without departing from the teachings of the present disclosure.

The terminology used herein can imply actions, processes or events performed by a actor or identically agent referred to as “user”.

The terminology used herein is for describing particular example embodiments and is not intended to be necessarily limiting of the present disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof.

Unless otherwise defined, all terms (including technical terms) used herein have the same meaning as commonly understood by one of ordinary skill in the art to which this disclosure belongs. The terms, such as those defined in commonly used dictionaries or encyclopedias, should be interpreted as having a meaning that is consistent with their meaning in the context of the relevant art and should not be interpreted in an overly idealized and/or overly formal sense unless expressly so defined herein.

Furthermore, relative terms such as “below,” “lower,” “above,” and “upper” can be used herein to describe one element's spatial relationship to another element as illustrated in the accompanying drawings. Such relative terms are intended to encompass different orientations of illustrated technologies in addition to the orientation depicted in the accompanying drawings. For example, if a device in the accompanying drawings were turned over, then the elements described as being on the “lower” side of other elements would then be oriented on “upper” sides of the other elements. Similarly, if the device in one of the figures were turned over, elements described as “below” or “underneath” other elements would then be oriented “above” the other elements. Therefore, the example terms “below” and “lower” can encompass both an orientation of above and below.

As used herein, the term or is intended to mean an inclusive or rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

As used herein, the term “about” and/or “substantially” refers to a 10% (from −10% to +10%) variation from the nominal value/term. Such variation is always included in any given value/term provided herein, whether or not such variation is specifically referred thereto. If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

In one aspect, a system provides the ability for a user to create a scene from a raw image that has been uploaded onto a server that has been processed and joined with other components to make a final digital image that can be placed onto a variety of physical products either by printing or attaching A photograph or visage onto a physical item. For example, A user can use several images of faces and for each of those faces create a cartoon body derived from the algorithmic approach and place those cartoon bodies onto an existing piece of artwork that reflects a specific holiday or occasion. For another example and image processing software can take images generated from the aforementioned scheme and add customize text to personalize specific product for a specific holiday or occasion.

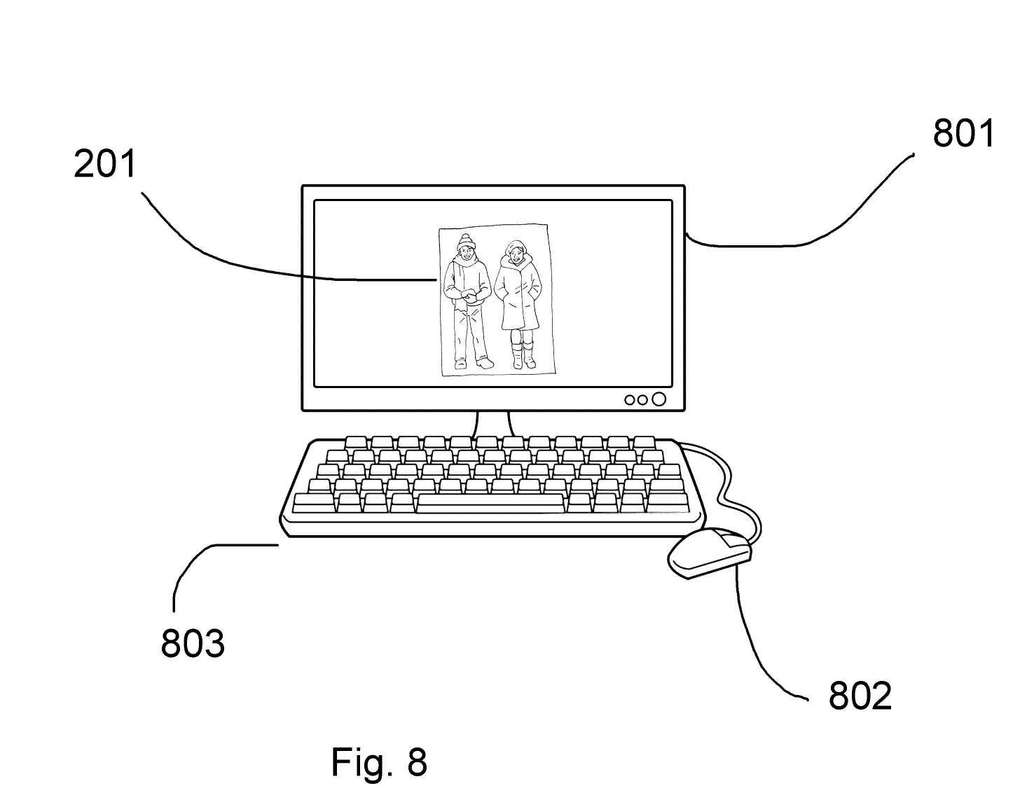

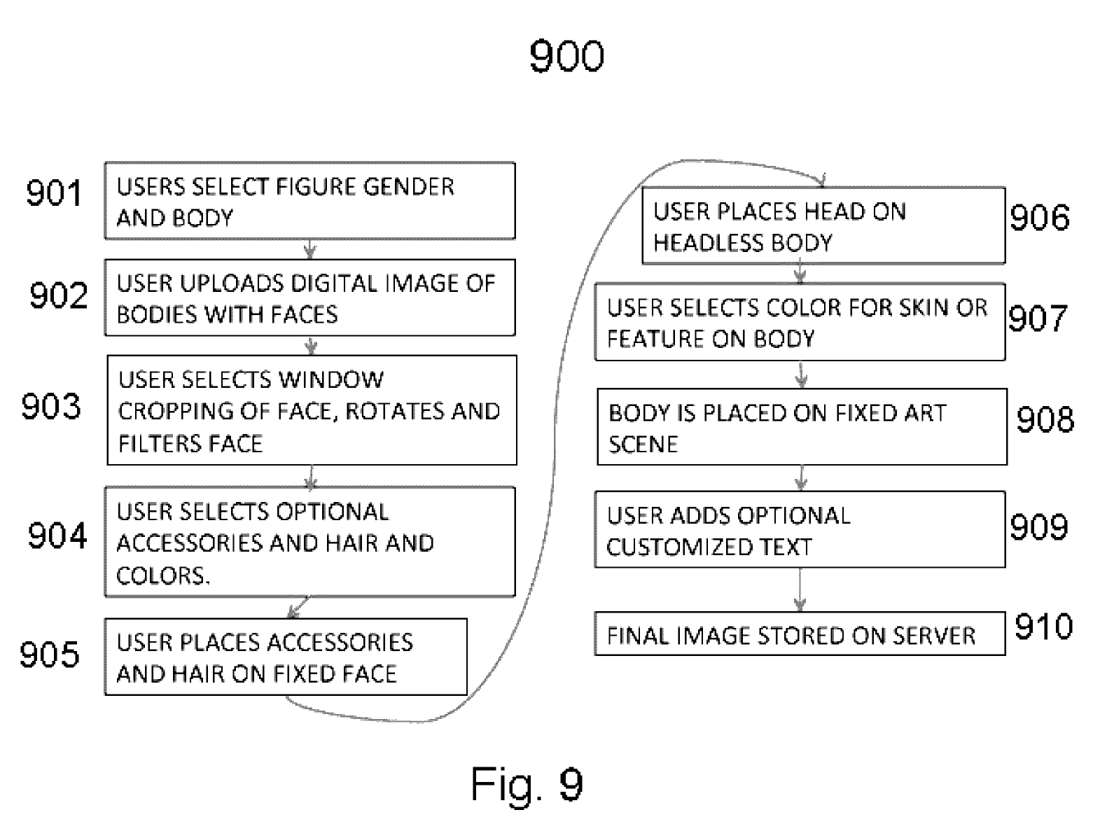

FIG. 9 shows a flowchart of an example embodiment of a process for the generation of an image according to the present disclosure. A process 900 is used for the image generation and described herein. The process 900 is performed via at least one actor, such as a via a user operating a laptop or computer of FIG. 8. The process 900 includes a plurality of blocks 901-910, which are performed consecutively.

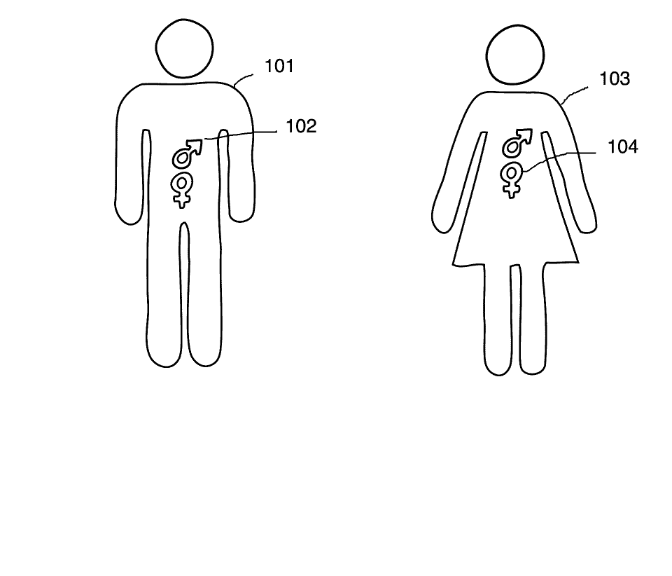

In block 901, a selection is made with respect to a predefined gender criteria of available digital image files. For example, if a selection is made for a symbol referring to one gender, digital image files of only that gender are available. FIG. 1A shows the first possible configuration one may be able to proceed with processing, but selecting a figure in configuration spot 101 represented in block 101, with a choice for possible options of gender presets represented by 102. Similarly, a different configuration can be selected in spot 103 with either choice of gender as indicated by the buttons 104.

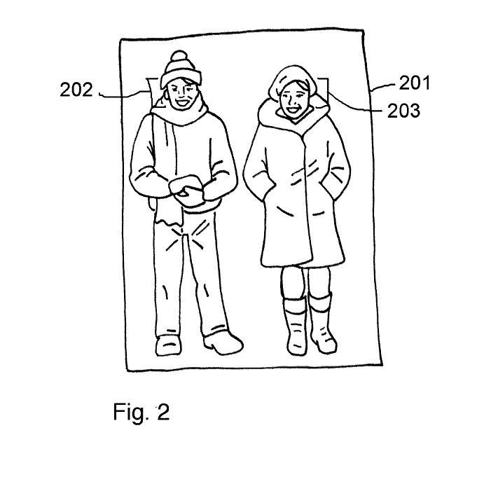

In block 902, a digital image is transmitted to the computer, by means of a image device or address, on a remote or local computer. FIG. 2 shows a digital image that has been been displayed via a computer. This image can be derived from a digital file on the remote computer of the user or otherwise obtained from another remote location on the internet and copied for the purposes of analysis on the server performing the analysis. An example of this image would be from a web server that contains either a Joint Photographic Export Group (JPEG) digital image format or a portable network graphic (PNG) digital image format. The location of this can be a social media server, like from internet connected servers hosting digital images .

Both blocks 202 and 203 represent represent clear digital representations of faces within an image copy located on a server. Block 202 represents the face on the left figure and block 203 represents the face of the right figure in image 201. A digital representation of image 201 is hosted on the server.

The image depicted by 201 is shown once the person has selected a digital image and is shown in order to confirm a proper image is selected to be processed using the procedure described herein. The algorithm contains several steps and is modular and can be repeated for the same image 201 for both face 202 and face 203. The algorithm can be run on one more new images to repeat the process of generating a new figure, or restarting a new figure.

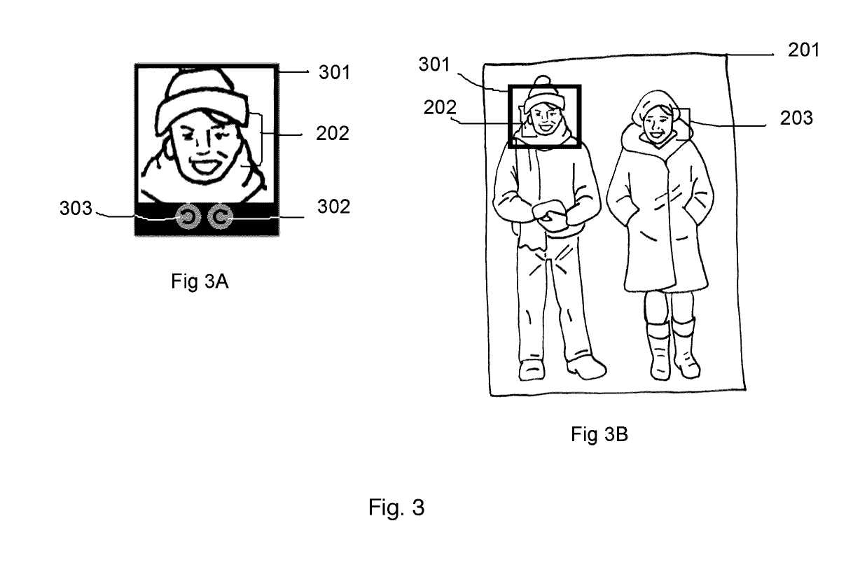

In block 903, a selection is made upon a digital image to adjust the size, orientation and filter of said digital image. FIG. 3B defines the selection of a digital representation of the head of a body in a digital image, referred to herein as a “cropped head”. Block 202 encompasses the head within a bounded box defined by four coordinates in block 304, in a pixel representation stored within the server, for the upper-left, lower-left, upper-right and lower-right extents of the box. The box extents can be captured through a user input device such as a trackpad, mouse or mobile device input device as indicated by 802. The locations of these coordinates are defined by initiating the placement of a coordinate system by means of a cursor on any corner, and maintaining an action to the input device, or “dragging”, to the preferred corner on the opposite side of the preferred box width in order to capture the entire face to be processed through the proceeding steps of the algorithm. If the selection of the coordinate is started again, for example, to capture the extent of the face contained in block 203, the single coordinates of the containing box will be redrawn to encompass that face in block 203.

FIG. 3A contains a digital image window contained in block 201 that reflects, in real time as the box in block 201 is adjusted to contain a digital image copy of the face in block 202 noted by block 202. The digital image can be rotated with respect to the center of the square coordinate counter-clockwise a set number of degrees-widths. Example degrees widths include 1°, 2°, 3°, 4°, 5°, 6°, 7°, 8°, 9°, and 10°.

408 may be selected by a digital input device, such as 802, and dragged across the length of 409 in to determine the extent level of a function to determine the gradient of the face in order to artistically manipulate the digital photograph. The location of 408 on 409 corresponds to a numerical value that can be used in a mathematical equation to determine strength of features.

The digital image is processed using a mathematical process to determine the magnitude of the gradient of the image. This is made by converting each pixel value into a linear, one channel image, referred to herein as the “grayscale” image. The amount of thresholding of the gradient directly corresponds to the placement of 408 on 409, varying from 0, 10, 20, 30, 40, 50, 60, 70, 80, 90 or 100 percent threshold image, containing black and transparent pixels.

Composing refers to the digital placement of a digital image file with respect to any number of other image files, containing transparent, black and color pixels. For every method of composing, each pixel contains color and information regarding order placement within several other composed digital images. For example, if three images are composed upon one another, the image generated show the lowest ordered pixel if and only if all higher ordered layer pixels are transparent. If a lowest ordered pixel is transparent and a higher ordered pixel is a color or black, the higher ordered pixel is generated. If a all pixels for a location in a layer are transparent, the image generated will preserve that transparency for that pixel location.

This image is regenerated automatically for each new placement of 408 on 409, and composed over a digital copy of the original image that has been blurred by means of applying a Gaussian blurring filter.

The Gaussian blurring filter performs a function on the digital image to reduce noise between pixels and decrease pixel variance in each color channel. Color channels can be either red, blue and green, referred to herein as RGB, or CMYK, cyan, yellow, magenta and key.

The digital image in FIG. 3B will represent the changes reflected in rotation upon each interaction with blocks 302 or 303, with set degree-widths preserved if the box window in FIG. 3B is reset by re-selecting a box. When the selection of the selected image is made, there is a selection made by means of a button or a feature indicating the procession into the proceeded step of the process. The image and orientation in block 301 is stored in digital memory, and referred to herein as “completed raw face” along with the stored degree-width offset and used as inputs of the function for the next feature.

In block 904, a selection is made to select additional face accessory digital image files to be placed on the “completed raw face”.

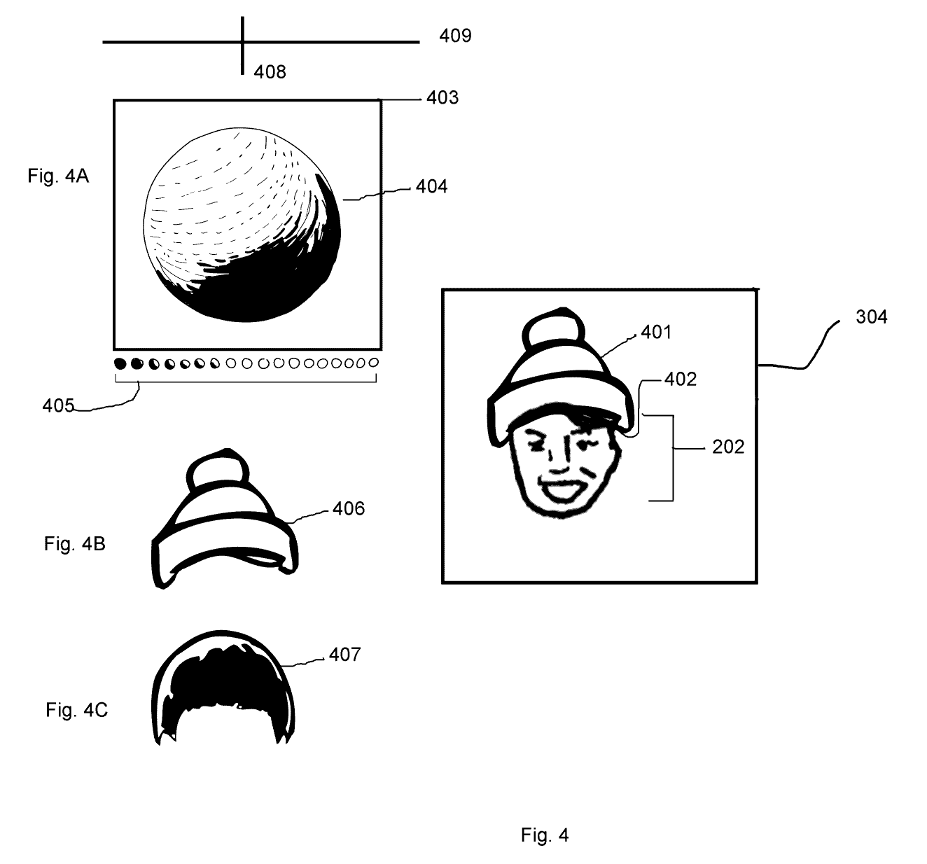

In block 905, a selection is made to the location of the additional face accessory digital image files with respect to the “completed raw face”. The image in block 301 is stored as a temporary digital file and displayed in block 202 in FIG. 4D. The user may select a hairstyle in FIG. 4C. The color of the digital hair selected can be adjusted by means of a wheel containing pixels of commonly used colors referred to as a color wheel contained in block 404 of FIG. 4A. The wheel contains a range of colors which will automatically update, once a color is selected, the features in the digital hair image, containing transparent, black and color pixels, in FIG. 4C. The images can selected by means of a digital input selector, such as a trackpad or other input, such as seen in 802, to drag the component in block 407 and block 406 onto block 202, such that block 202 is fixed in space and moveable block 402 can be placed by dragging, and block 401 can be placed by dragging. The final image contains the three components blocks 401, 402 and 202 within one digital image set consisted of black, transparent and color pixels.

FIG. 4B refers to an optional digital image that contains transparent, black and color pixels that can be placed by dragging unto the face and hair. One the user places or elects not to place the optional figure in block 406, the completed composition of blocks 401, 402 and 202, containing transparent, black and color pixels, will herein be referred to as the “completed digital face”.

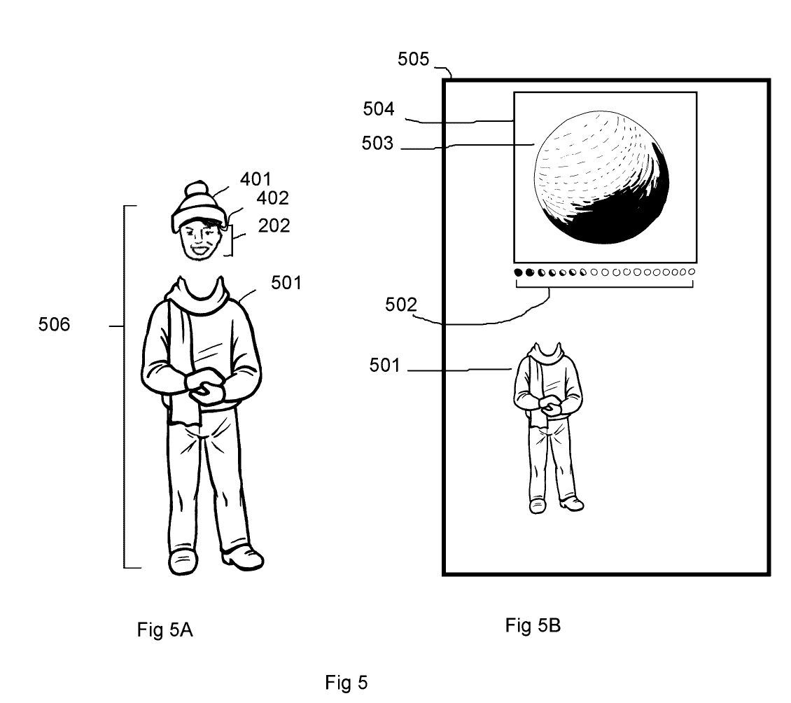

In block 906 a selection is made to the location of the “completed digital face” with respect to a digital image file representing the visage of a body, herein referred to as the “headless body”. FIG. 5 refers to the proceeding scene whereby a “completed digital face”, consists of the composition of blocks 401, 402 and 202, is placed, by means of a cursor or other digital input device, such as seen in 802, onto a digital image of the “headless body”, consisting of transparent, black and color pixels. The “completed digital face” is then placed onto the headless body features in block 501 by dragging the image in free space, where the body is in fixed space. The choice of the body can be selected, within the box encased in block 505, by selecting a smaller image in block 501 representing the same image with larger dimensions in block 501. Block 501 may contain pixels with adjustable colors that can be selected by one of two ways, by either selecting a colored pixel from a color wheel represented by block 503 in selection window block 504 or by pre-selected one of several colors in block 502.

In block 907 a selection is made for optional coloring of colored pixels on the “headless body”. Upon selection of a color for the body and the placement of the “completed digital face”, the composition the “completed digital face” upon the body generates the “completed digital body”, which is a digital image comprised of transparent, black and color pixels.

The “completed digital body” generation can be repeated for as many predefined body features are available for a given scene, and the image stored in digital memory along and used as inputs of the function for the next feature.

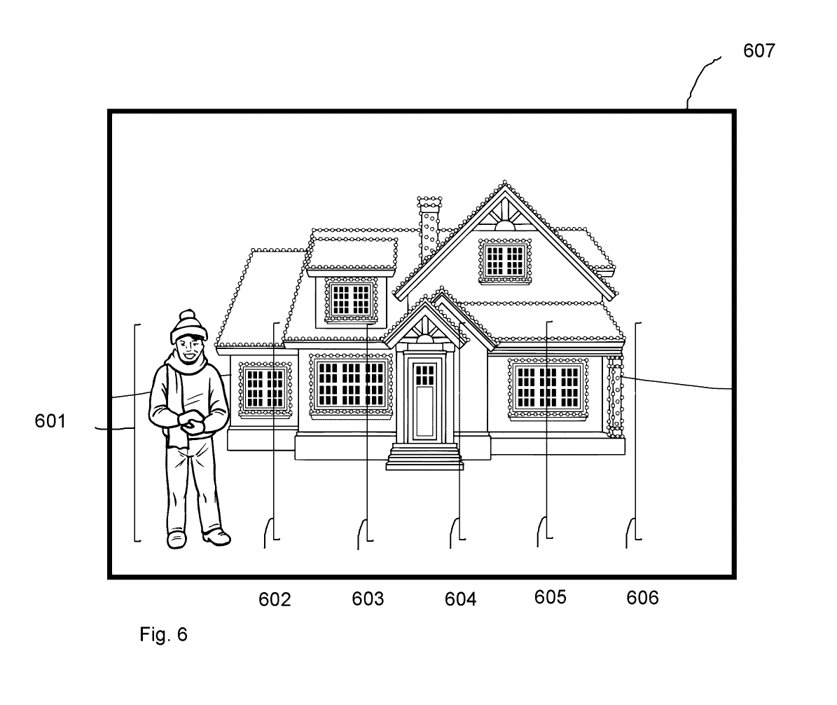

In block 908 a “completed digital body” is placed in digital space upon the scene. FIG. 6 represents the placements of a number of “completed digital bodies” onto a pre-defined graphical scene represented by block 607. The scene is fixed in space and the placement of a “completed digital body”, as shown with block 601, occurs after completion and the creation of both the “completed digital face”, all customizations and placements previously performed, and the “completed digital body”, and all customizations and placements previously performed. The process of generating a new customized body can be repeated to be placed within blocks 602, 603, 604, 605, or 606, for which there are a total of 1, 2, 3, 4, 5 or 6 possible characters that may be placed into a scene. The limit to the number of bodies to be placed on a scene is determined by a pre-defined, and no more than the pre-defined numbers of bodies may be placed. The completed placement of any number of “completed digital bodies” onto the scene will be composed and that digital image, representing a collection of transparent, black and color pixels, will be herein referred to as “completed digital scene”, and is stored into memory as input for a proceeding customization step

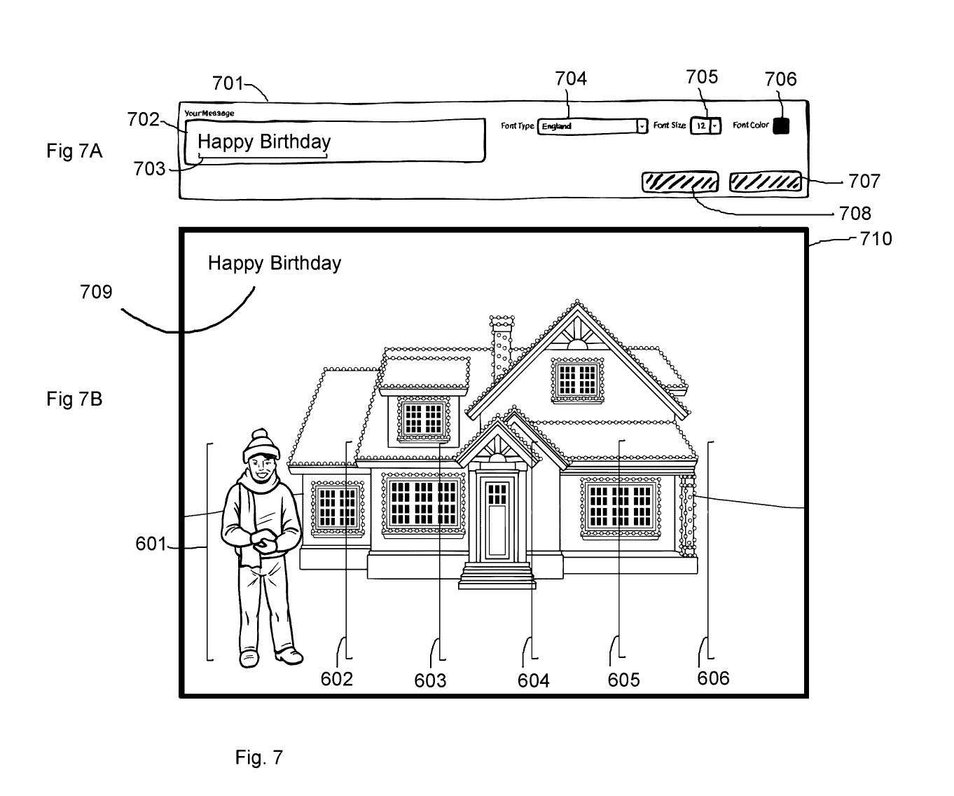

FIG. 7B represents the “completed digital scene”, with a “completed digital body” shown in block 601, within a fixed scene in block 607. Unused vacant spaces for other “completed digital bodies” are shown in blocks 602, 603, 604, 605 and 606.

In block 909 a selection for input generated text rasterized into a digital image is made that is placed, in pixel form, on the “completed digital scene” in a location that is determined by a pre-defined property of the scene.

FIG. 7A represents a customization panel shown in block 701 for the generation and editing of text to be added to the scene located at block 709. Text is entered by means of a keyboard by entering, using a keyboard or keyed input device, such as seen in 803, words or letters represented by block 702 into box 703. Font selection is made from a drag down field in block 704. Font size is made from a drag down field in block 705. Font color is made from a drag down field in block 706.

The process of composing the text found on block 702 onto the scene in block 607 on the location of block 709 can be reset by selecting the action represented by block 707. The process of removing composed text that had been previously composed using the action of block 49 can be performed by the action of block 708.

In block 910 an image is stored into digital memory that comprises the resulting image from the action performed following the image generation of block 909. The composing of text onto a “completed digital scene” generates an image file herein referred to as the “completed digital product”, which is a collection of transparent, black and color pixels stored into digital memory.

FIG. 8 shows a desktop computer exemplifying the process of the present disclosure, where 801 represents a CPU and monitor, but can be expanded to include a server located at a remote location, 802 represents an input device such as a mouse or, in the case of a laptop computer, an incorporated trackpad device, and 803 represents a keyed input device or keyboard. The preferred embodiment may be a laptop or a remote server, such as viewed through a VNC protocol.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

In some embodiments, an apparatus or system comprise at least one processor, and memory storing instructions that, when executed by the at least one processor, cause the apparatus or system to perform one or more methodological acts as described herein. In some embodiments, the memory stores data, such as one or more structures, metadata, lines, tags, blocks, strings, or other suitable data organizations.

As will be appreciated by one skilled in the art, aspects of this disclosure can be embodied as a system, method or computer program product. Accordingly, aspects of the present disclosure can take the form of an entirely hardware embodiment, an entirely software embodiment (including firmware, resident software, micro-code, etc.) or as embodiments combining software and hardware aspects that can all generally be referred to herein as a “circuit,” “module” or “system.” Furthermore, aspects of the disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific example (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing.

Computer program code for carrying out operations for aspects of the present disclosure can be written in any combination of one or more programming language, including an object oriented programming language, such as Java, C++ or the like and conventional procedural programming language, such as the “C” or Python programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the steps can be performed in a differing order or steps can be added, deleted or modified. All of these variations are considered a part of the disclosure. It will be understood that those skilled in the art, both now and in the future, can make various improvements and enhancements which fall within the scope of the claims which follow.

1. A method comprising:
selecting, via a computer, a sample configuration that fits aligns into an image of existing artwork that can be manipulated;
selecting, via the computer, a second image, from an area that encompasses the square boundary of a first image;
applying, via the computer, a filter to the second image;
generating, via the computer, a third image generated from the placement of the second image onto a fourth image;
generating, via the computer, a fifth image from the placement of the a third image onto a sixth image.

2. A method of claim 1, further comprising:
performing, via the computer, an adjustment of color replacement to at least the second, third, fourth, fifth or sixth images.

3. A system comprising:
an input device, such as a mouse or trackpad;
a hardware processor unit;
a memory connected to a hardware processor unit, wherein the instructions instruct the hardware processor to perform a method comprising:
selecting a sample configuration that fits aligns into an image of existing artwork that can be manipulated;
selecting a second image, from an area that encompasses the square boundary of a first image;
applying a filter to the second image;
generating a third image generated from the placement of the second image onto a fourth image;
generating a fifth image from the placement of the a third image onto a sixth image.

4. A system of claim 3, wherein the method further comprising:
performing an adjustment of color replacement to at least the second, third, fourth, fifth or sixth images.

5. A storage device storing a set of instructions to execute via a processing circuit to implement a method comprising:
selecting, via a computer, a sample configuration that fits aligns into an image of existing artwork that can be manipulated;
selecting, via the computer, a second image, from an area that encompasses the square boundary of a first image;
applying, via the computer, a filter to the second image;
generating, via the computer, a third image generated from the placement of the second image onto a fourth image;
generating, via the computer, a fifth image from the placement of the a third image onto a sixth image.

6. The storage device of claim 5, wherein the method further comprising:
performing an adjustment of color replacement to at least the second, third, fourth, fifth or sixth images.
